(19) United States
(12) Patent Application Publication
(10) Pub. No.: US 2007/0029997 A1
(43) Pub. Date: Feb. 8, 2007

(54) Test circuit with drive windings and sense elements

(76) Inventors: Neil J. Goldfine, Newton, MA (US); Darrell E. Schlicker, Watertown, MA (US); Karen E. Walrath, Arlington, MA (US); Andrew P. Washabaugh, Chula Vista, CA (US); David C. Grundy, Reading, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/415,396

(22) Filed: May 1, 2006

Related U.S. Application Data
(60) Provisional application No. 60/676,786, filed on May 2, 2005.

(51) Int. Cl. G01N 27/82

(52) U.S. Cl. 324/240

(57) ABSTRACT

Magnetic field based eddy-current sensing arrays measure the near surface properties conducting and magnetic materials. The arrays have a drive winding for imposing the magnetic field in a test material and at least two sense elements for sensing the response of the test material to the magnetic field. Each sense element has distinct leads for connection to impedance measurement instrumentation. The arrays have accurately positioned sense elements and drive winding conductors so that the sense element responses are essentially identical for test materials having uniform properties. The drive windings are typically formed into circular loops for examining material properties in the vicinity of circular features in the test material, such as holes or fasteners. For examining the material, the sensor arrays are rotated around the feature or mounted against a material surface and provide information from multiple locations around the feature to determine if cracks are present or to monitor crack growth.

### RELATED APPLICATION(S)

This application claims the benefit of U.S. Provisional Application No. 60/676,786, filed on May 2, 2005. The entire teachings of the above applications are incorporated herein by reference.

### BACKGROUND OF THE INVENTION

The technical field of this invention is that of nondestructive materials characterization, particularly quantitative, model-based characterization of surface, near-surface, and bulk material condition for flat and curved parts or components. Characterization of bulk material condition includes (1) measurement of changes in material state, i.e., degradation/damage caused by fatigue damage, creep damage, thermal exposure, or plastic deformation; (2) assessment of residual stresses and applied loads; and (3) assessment of processing-related conditions, for example from aggressive grinding, shot peening, roll burnishing, thermal-spray coating, welding or heat treatment. It also includes measurements characterizing the material, such as alloy type, and material states, such as porosity and temperature. Characterization of surface and near-surface conditions includes measurements of surface roughness, displacement or changes in relative position, coating thickness, temperature and coating condition. Each of these includes detection of electromagnetic property changes associated with either microstructural and/or compositional changes, or electronic structure (e.g., Fermi surface) or magnetic structure (e.g., domain orientation) changes, or with single or multiple cracks, cracks or stress variations in magnitude, orientation or distribution. Spatially periodic field eddy-current sensors have been used to measure foil thickness, characterize coatings, and measure porosity, as well as to measure property profiles as a function of depth into a part, as disclosed in U.S. Pat. Nos. 5,015,951 and 5,453,689.

A common inspection and nondestructive characterization technique, termed conventional eddy-current sensing involves the excitation of a conducting winding, the primary, with an electric current source of prescribed frequency. This produces a time-varying magnetic field, which in turn is detected with a sensing winding, the secondary. The spatial distribution of the magnetic field and the field measured by the secondary is influenced by the proximity and physical properties (electrical conductivity and magnetic permeability) of nearby materials. When the sensor is intentionally placed in close proximity to a test material, the physical properties of the material can be deduced from measurements of the impedance between the primary and secondary windings. Traditionally, scanning of eddy-current sensors across the material surface is then used to detect flaws, such as cracks. A particular difficulty with eddy current sensors is the effect of material discontinuities, such as edges of the material or detecting cracks around fasteners. These edges and fasteners can strongly influence the response of the sensor and potentially mask the response of cracks that commonly form at these material discontinuities.

An example of such an eddy-current technique is in U.S. Pat. No. 5,399,968. In this patent, Sheppard, et al. teaches of eddy current probes for the inspection of cracks or flaws in multi-layered structures. Circular and rectangular probe designs are disclosed, with one or two drive winding coils and arrays of sensing element coils. The probes also use a ferrite core for creating a magnetic circuit that guides the magnetic flux into the test material.

### SUMMARY OF THE INVENTION

Aspects of the methods described herein involve nondestructive evaluation of materials for the presence of cracks, flaws, or defects, in the vicinity of and around features in the materials, such as holes or fasteners. In an embodiment, a eddy current sensor array, typically circular, is placed around a fastener and used to inspect for the presence of a crack and, when mounted against the surface or between layers, can be used to monitor the crack size as the damage, cycling, or loading, continues. The sensor has at least one drive loop for creating a time-varying magnetic field and sense elements for sensing the response of the test material to the magnetic field. Any flaws or cracks will interrupt the flow of induced eddy currents and lead to a change in the sense element response. The sense element can be a small single element that is rotated around the drive winding to sense the response at different angular positions around the hole or fastener. Multiple sense elements can be used, equally spaced around the hole or fastener, provide simultaneous monitoring of the condition around the hole circumference. Sense elements may be placed at different radial positions to provide sensitivity to different segments of the magnetic field that penetrate to different depths into the test material. The drive loop can be fabricated from the same microfabrication techniques used to make planar conductors for the sense elements and may be placed on a common substrate with the sense elements. Alternatively, the drive winding may be a coil having discrete windings. In either case, the conductors for the drive windings and sense elements are fabricated with a technique that provides sufficient placement accuracy that that the sense elements provide essentially identical responses when measuring a material with uniform electrical properties.

In another embodiment, a second drive loop is placed near the inside radius of the sense elements. The current can be in the same direction as the outer drive winding loop, to maximize the effective spatial wavelength for the drive winding so that more of the magnetic field energy penetrates to a deeper depth. The magnitude and phase of the current in the inner drive loop can also be adjusted to improve the sensitivity of the sense element response to a particular material condition. For example, the current may be driven out of phase to cancel the net flux going into the fastener. Alternatively, the magnitude and phase can be adjusted so that the net flux through one or more sense elements is zero, either in air or over the test material. In addition, the response of the sense elements can be used to adjust the sensor position and, for circular sensors, can be used to align the center of the sensor with the center of circular features such as fasteners. This includes using different excitation frequencies and/or different relative current directions in the drive winding loops for centering or for inspecting for damage.

A planar test circuit may comprise a drive winding, the drive winding comprising one or more planar electrical conductors deposited on a substrate for imposing a field in a test material when driven by an electrical current, all of the electrical current flowing in one direction about an axis. The test circuit further comprises at least two planar sense elements proximate to and spaced along the electrical conductors of the drive winding for sensing the response of the test material to the imposed field. Leads connect to each sense element. An inner drive winding loop may, for example, be placed in a layer with the sense elements and not in the same layer as an outer drive winding loop. Each winding may further comprise a single conductive layer on a substrate in a substantially planar structure. However, the separation between these layers is relatively small compared to the thickness of typical drive coils. The planar structure of the test circuit reduces the cost and complexity of manufacturing and provides a low mass circuit, the response of which can be modeled.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 shows a schematic diagram of a four sense element circular sensor array.

FIG. 2 shows a schematic diagram of a circular sensor array with four small sense elements.

FIG. 3 shows a schematic diagram of a seven sense element circular sensor array.

FIG. 4 shows a representative measurement grid relating the magnitude and phase of the sensor terminal impedance to the lift-off and magnetic permeability.

FIG. 5 shows a representative measurement grid relating the magnitude and phase of the sensor terminal impedance to the lift-off and electrical conductivity.

FIG. 6 shows a cross-sectional view of a circular sensor array positioned over the top of a fastener.

FIG. 7 shows a sensitivity plot as the frequency is varied for several elements of a circular sensor array for a notch under a fastener head and current through an inner winding loop.

FIG. 8 shows a sensitivity plot as the frequency is varied for several elements of a circular sensor array for a notch under a fastener head and current through an outer winding loop.

FIG. 9 shows a sensitivity plot as the size of the inner drive winding loop is varied.

FIG. 10 shows a cross-sectional view of a circular sensor array mounted around a fastener and between material layers.

FIG. 11 shows a cross-sectional view of a circular sensor array with sense elements mounted around a fastener and between material layers and with drive windings positioned over a material layer and fastener head.

FIG. 12 shows a plot of the effective conductivity variation with frequency and crack size for a sensor array mounted between material layers.

FIG. 13 shows a plot of the effective lift-off variation with frequency and crack size for a sensor array mounted between material layers.

FIG. 14 shows a cross-sectional view of a circular sensor placed over the top of fastener that passes through a sealant groove.

FIG. 15 shows a sensitivity plot for a notch in a sealant groove for a small sense element at different positions around a fastener with current only through an outer drive winding loop.

FIG. 16 shows a sensitivity plot for a notch in a sealant groove for a small sense element at different positions around a fastener with current through both an inner and outer drive winding loops.

FIG. 17 shows a cross-sectional view of a circular sensor placed over a fastener and test material.

FIG. 18 shows a plot of the real part of the impedance at a frequency of 251 Hz as the sense element position and alignment of the sensor with the fastener are varied.

FIG. 19 shows a plot of the imaginary part of the impedance at a frequency of 251 Hz as the sense element position and alignment of the sensor with the fastener are varied.

FIG. 20 shows a plot of the real part of the impedance at a frequency of 2.5 kHz as the sense element position and alignment of the sensor with the fastener are varied.

FIG. 21 shows a plot of the imaginary part of the impedance at a frequency of 2.5 kHz as the sense element position and alignment of the sensor with the fastener are varied.

FIG. 22 shows a sensitivity plot at a frequency of 251 Hz as the sense element position and alignment of the sensor with the fastener are varied.

FIG. 23 shows a sensitivity plot as in FIG. 22 except the inner drive winding loop radius is reduced.

FIG. 24 shows a sensitivity plot as in FIG. 22 except no current flows through the inner drive winding loop.

### DETAILED DESCRIPTION OF THE INVENTION

A description of preferred embodiments of the invention follows.

The design and use of conformable eddy current sensor arrays are described for the nondestructive characterization of materials in the vicinity of and around features in the materials, such as holes or fasteners. For circular features, this is accomplished with circular magnetic field sensor arrays. Often the geometry changes and any material property (e.g., electrical conductivity and/or magnetic permeability) differences between the feature and the surrounding material can mask the presence of flaws or defects. An example is a fastener for joining material layers, such as a magnetizable steel fastener joining aluminum or titanium alloy layers, where the geometric and material property differences can dominate the sensor response signals and mask the response signals from hidden cracks located beneath the head of the fastener. However, the sensors can be designed to match the symmetry of the test material geometry or the sensors can be scanned around the feature or mounted to the test material surface in a manner that takes advantage of this symmetry. This allows the sensitivity to the background property changes to be reduced so that the presence or size of a flaw or defect can be more readily ascertained. These magnetic field sensor designs can be fabricated with accurately positioned drive winding conductors and sense elements so that the sense element responses are essentially the same for unflawed materials and reduces the influence of the fastener on the examination response.

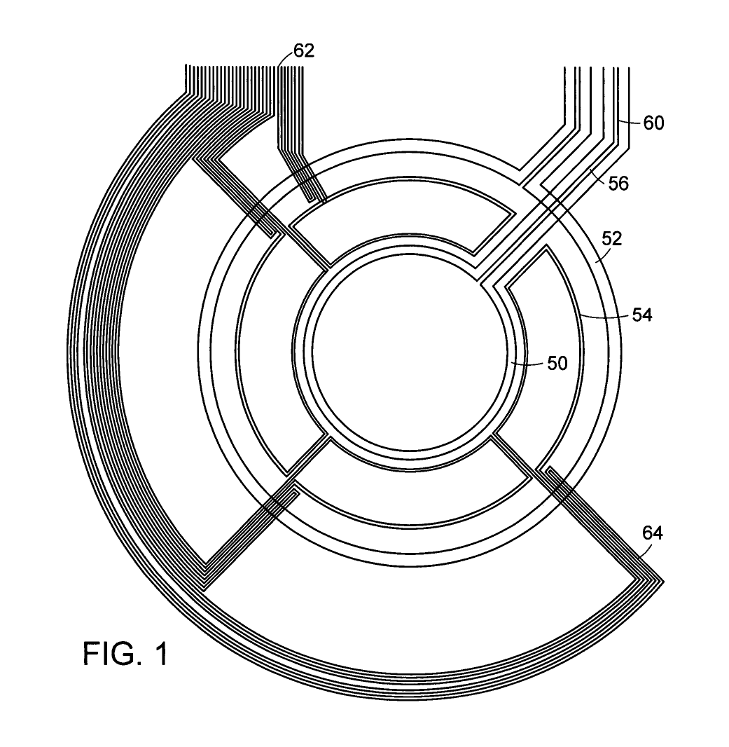

FIGS. 1-3 show examples of such eddy current sensor arrays. The substantially planar arrays include two circular drive winding conductors (50 and 52) that create a magnetic field when driven by an electric current. There is a plurality of secondary (sense) elements 54 in a single plane which, in this case, are circumferential with the drive winding conductors. The secondary elements 54 sense the response of the material under test (MUT) to the imposed magnetic field. A time-varying current is applied to the primary winding, which creates a magnetic field that penetrates into the MUT and induces a voltage at the terminals of the secondary elements. This terminal voltage reflects the properties of the MUT. Connection leads 62 to each sense element allow the sense elements to be connected to measurement instrumentation that allows the response for each sense element to be determined. The sense elements 54 span the circumference around the sensor array and provide complete coverage for detecting and monitoring radial crack growth with a sensor array mounted against a material surface.

In order to minimize coupling to stray magnetic fields, the leads to the drive windings and the sense elements are made relatively close together. For example, the gap 60 between the drive winding loop leads 56 is made as small as possible, typically to within the practical limitations of the fabrication process, in order to minimize the creation of stray magnetic fields. Similar, the leads to the sense elements 62 are made close together and placed at a distance from the drive winding leads in order to reduce stray coupling of the magnetic field. To further reduce the effects of stray coupling to the sense element leads, additional conductors 64 that parallel the sense element leads and terminate in a cross-connection near the sense element can be used to compensate for stray coupling to the sense element leads. These leads can be in a flux canceling configuration that essentially cancels any parasitic flux coupled to the leads, as described in U.S. patent application Ser. Nos. 09/666,879 and 09/666,524, both filed on Sep. 20, 2000, which have subsequently been granted as U.S. Pat. Nos. 6,657,429 and 6,952,095, respectively, the entire teachings of which are incorporated herein by reference. The connection leads are typically perpendicular to the drive winding conductors.

In operation, a single drive winding loop may be used. However, the base sensor response and the depth of penetration of the magnetic field into the test material can be altered by adjusting the relative magnitude and phase of the current glowing through the two windings. For example, if the windings are connected in series so that the current flow is in the same angular direction, the resulting magnetic fields from the drive winding loops add and the magnetic field penetrate relatively deeply into the test material. However, if the current flows in opposite directions, the magnetic fields somewhat cancel each other and the depth of penetration is reduced. Note that if there are numerous windings connected with alternating current directions, a circular spatially periodic field can be formed as described in the U.S. Pat. Nos. 6,657,429 and 6,952,095. Also, additional circuitry can be placed in series with one of the drive winding loops to adjust the relative magnitude and phase of the current. As described later, this can null zero the response of the sense elements, which allows any amplification of the sense element signal to be increased without saturating any associated electronics.

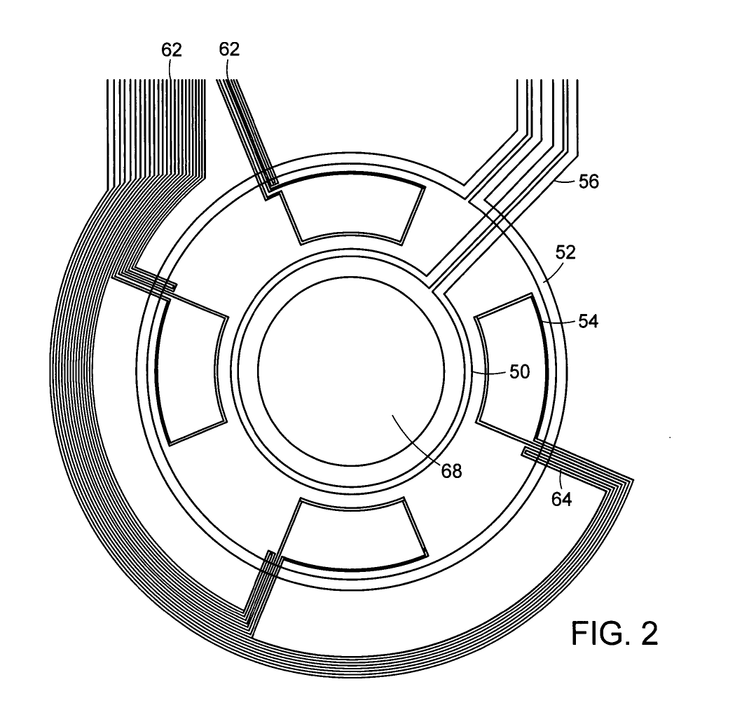

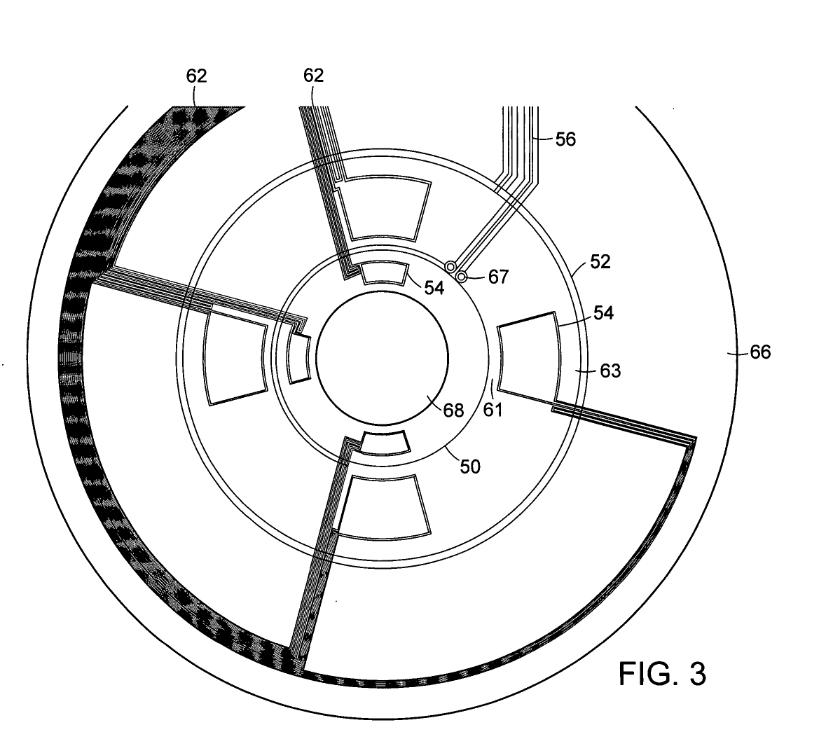

FIG. 3 shows a seven element circular sensor array. In comparison to FIGS. 1 and 2, there is an additional set of sense elements 55 located within the inner drive winding loop 50. These inner sense elements 55 can be grouped into pairs with the outer sense elements 54 at different circumferential positions around the drive windings. These sense elements are smaller then the equally spaced sense elements 54 positioned at a larger radius from the center of the drive winding loops. Typically, the sizes (angular span and radial distance) are adjusted so that the sense element responses with respect to a uniform material, even air, are comparable so that minimal modifications to the electronics are required for using the different sense elements. Furthermore, placing the sense elements at different radial distances and adjusting the gaps 61 and 63 between the sense element conductors and the drive winding conductors, permits sensitivity to different components of the magnetic field distribution that have different depths of penetration into the test material. This sensing of different magnetic field segments within a single winding construct is similar to that described for linear sense element arrays in U.S. patent application Ser. No. 11/056,334, filed on Feb. 11, 2005, the entire teachings of which are incorporated herein by reference.

In FIGS. 1-3, in order for the leads 56 to connect to the inner drive loop 50 without passing through the outer drive loop 52, the leads are placed in a different plane from the conductors for the outer drive loop. This implies that the inner drive winding loop leads 56 are fabricated on a different layer and a layer of insulation (66 in FIG. 3) is placed between the layers of conductors. Similarly, the leads to the sense elements 62 are also placed in a different layer than the outer drive winding loop conductor. Note in FIGS. 1 and 2 that the inner drive winding loop 50 and sense elements 54 are in one layer while the outer drive winding loop 52 is in a different layer. In contrast, in FIG. 3, the inner drive winding loop 50 is the same plane as the outer drive winding loop 52. The inner drive winding leads 56 are connected to the drive winding loop 50 through vias 67 in the insulation layer. Thus, depending upon the configuration desired, the sense elements and drive windings may be in the same or different layers. When the sense elements are in a different layer than the drive windings, the drive windings can be fabricated in a spiral pattern so that additional drive winding turns can be introduced. Note also that an opening 68 can be introduced into the insulation layer 66 at the center region of the sensor in order to allow the sensor to be placed around features in the test material, such as the raised heads around some fasteners, such as button head or non-flush mount fasteners.

Conventional eddy current sensors or sensor arrays using wound coils typically have high signal levels, due to the large number of turns in the coils, but do not provide predictable responses or responses that can be modeled accurately. As indicated by Auld and Moulder, for conventional eddy-current sensors “nominally identical probes have been found to give signals that differ by as much as 35%, even though the probe inductances were identical to better than 2%” [Auld, 1999]. The lack of reproducibility with conventional coils introduces severe requirements for calibration of the sensors (e.g., matched sensor/calibration block sets). Furthermore, during inspections, the drive and sense windings are typically at different and uncontrolled distances from the test material so that the response cannot be modeled accurately. In contrast, sensors or sensor arrays that are produced using micro-fabrication techniques typically employed in integrated circuit and flexible circuit manufacture have highly reliable and highly repeatable (i.e., essentially identical) sensors but only one or several winding turns. This results in signal levels that tend to be much smaller than wound coils, but the sensor response can be accurately modeled and predicted, which dramatically reduces calibration requirements. In some situations an “air calibration” can be used to measure an absolute electrical conductivity without calibration standards. Furthermore, optical measurements can typically be performed on microfabricated sensor arrays so that the relative positions and dimensions of the relevant winding conductors, sense element conductors, and gaps between conductors can be determined and verified as desired.

Typically it is beneficial to convert the sense element response into more meaningful physical parameters associated with the test material, such as an electrical conductivity or magnetic permeability. In addition, if the sensor lift-off or proximity to the test material is determined, this provides self-diagnostic information about the state of the sensor, which is particularly useful for surface mounted sensor arrays where access to the sensor array may be limited. An efficient method for converting the sensor response into material or geometric properties is to use grid measurement methods. These methods map two known values, such as the magnitude and phase or real and imaginary parts of the sensor impedance, into the properties to be determined. The measurement grids are two-dimensional databases that can be visualized as “grids” that relate two measured parameters to two unknowns, such as the magnetic permeability (or electrical conductivity) and lift-off (where lift-off is defined as the proximity of the MUT to the plane of the MWM windings). For the characterization of coatings or surface layer properties, three-(or more)-dimensional versions of the measurement grids called lattices and hypercubes, respectively, can be used. Alternatively, the surface layer parameters can be determined from numerical algorithms that minimize the least-squares error between the measurements and the predicted responses from the sensor, or by intelligent interpolation search methods within the grids, lattices or hypercubes.

An advantage of the measurement grid method is that it allows for near real-time measurements of the absolute electrical properties of the material and geometric parameters of interest. The database of the sensor responses can be generated prior to the data acquisition on the part itself, so that only table lookup and interpolation operations, which are relatively fast, needs to be performed after measurement data is acquired. Furthermore, grids can be generated for the individual elements in an array, such as those that couple to different segments of the magnetic field distribution, so that each individual element can be lift-off compensated to provide absolute property measurements, such as the electrical conductivity. This again reduces the need for extensive calibration standards. In contrast, conventional eddy-current methods that use empirical correlation tables that relate the amplitude and phase of a lift-off compensated signal to parameters or properties of interest, such as crack size or hardness, require extensive calibrations using standards and instrument preparation.

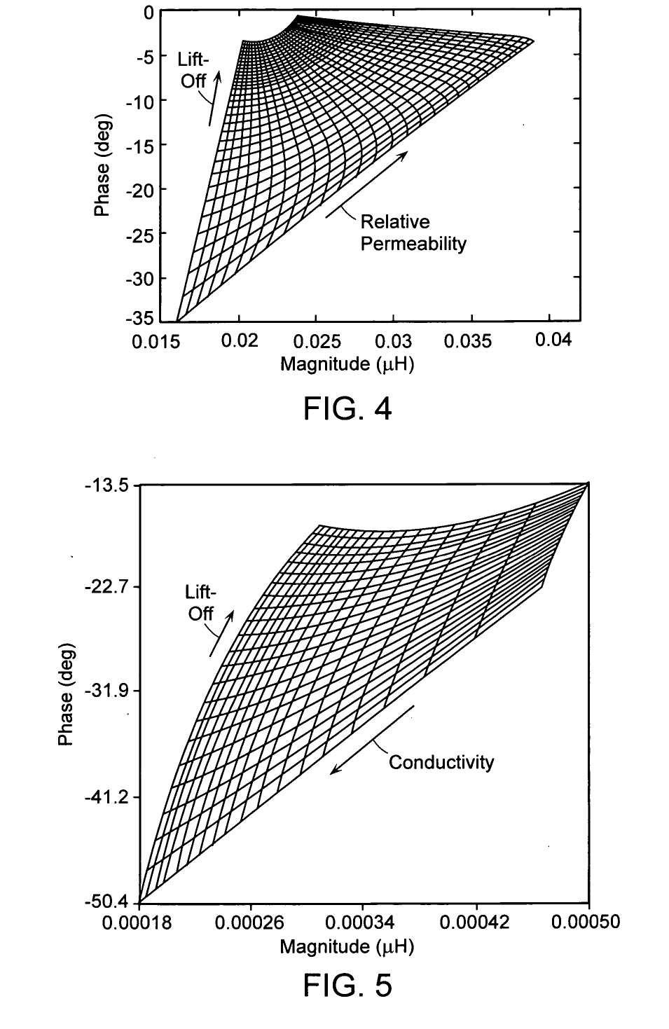

For ferromagnetic materials, such as most steels, a measurement grid can provide a conversion of raw data to magnetic permeability and lift-off. A representative measurement grid for ferromagnetic materials is illustrated in FIG. 4. A representative measurement grid for a low-conductivity nonmagnetic alloy (e.g., titanium alloys, some superalloys, and austenitic stainless steels) is illustrated in FIG. 5. For coated materials, such as cadmium and cadmium alloys on steels, the properties of the coatings can be incorporated into the model response for the sensor so that the measurement grid accurately reflects, for example, the permeability variations of substrate material with stress and the lift-off. Lattices and hypercubes can be used to include variations in coating properties (thickness, conductivity, permeability), over the imaging region of interest. The variation in the coating can be corrected at each point in the image to improve the measurement of permeability in the substrate for the purpose of imaging stresses. The effective property can also be a layer thickness, which is particularly suitable for coated systems. The effective property could also be some other estimated damage state, such as the dimension of a flaw or some indication of thermal damage for the material condition.

In addition to inductive coils, other types of sensing elements, such as Hall effect sensors, magnetoresistive sensors, SQUIDS, Barkhausen noise sensors, and giant magnetoresistive (GMR) devices, can also be used for the measurements. The use of GMR sensors for characterization of materials is described in more detail in U.S. patent application Ser. No. 10/045,650, filed Nov. 8, 2001, the entire teachings of which are incorporated herein by reference. Conventional eddy-current sensors are effective at examining near surface properties of materials but have a limited capability to examine deep material property variations. GMR sensors respond to magnetic fields directly, rather than through an induced response on sensing coils, which permits operation at low frequencies, even DC, and deeper penetration of the magnetic fields into the test material. The GMR sensors can be used in place of sensing coils, conventional eddy-current drive coils, or sensor arrays. Thus, the GMR-based sensors can be considered an extension of conventional eddy-current technology that provides a greater depth of sensitivity to hidden features and are not deleteriously affected by the presence of hidden air gaps or delaminations.

Numerous simulations were performed to help determine the effect of design modifications to the sensor geometry on the sensitivity to a crack or notch under fastener heads. These included the dimensions of the drive windings and sense elements and the gaps between the sense elements and drive windings. Many of these simulation results were verified with subsequent measurements on the material samples of the relevant geometry.

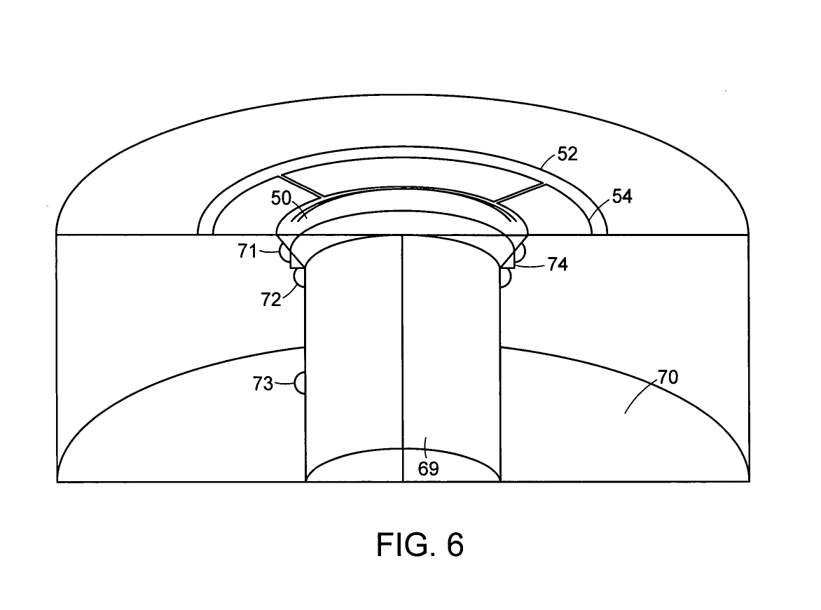

FIG. 6 shows a representative image for an example simulation geometry. In this case, a fastener 69 is placed in a material 70 having two layers of similar electrical properties. The hole for the fastener includes a countersink so that the fastener head is flush with the material surface. In this case, the fastener hole also included a counter bore (74) for placement of a sealant ring. For this geometry, cracks tend to form at a number of locations, including under the fastener head (71), under the counter bore (72) or near the middle of the shank (73). For this set of simulations, it was assumed that the crack or notch was centered underneath the first sense element. Current was passed through either the inner winding 50 or outer winding 52 to create the interrogating magnetic field. The magnetic flux linked by each sense element loop 54 was then determined. In this case, the inner radius for the sense element loops was 0.135 in. while the outer radius was 0.220 in. The inner winding loop radius was typically 0.130 in. The outer winding loop radius was typically 0.240 in. The spacing between the sense element loops was 0.003 in. The material in each layer of the test material was nonmagnetic. The upper layer was 0.250 in. thick and an aluminum alloy with an assumed conductivity of 37.5% IACS while the lower layer was 0.060 in. thick and the same aluminum alloy. Any gap between the layers was neglected. The sensor lift-off from the material surface was 0.010 in. The fastener was assumed to be nonmagnetic with an electrical conductivity of 1% IACS. The fastener shank had a radius of 0.095 in. and a maximum head radius of 0.150 in.

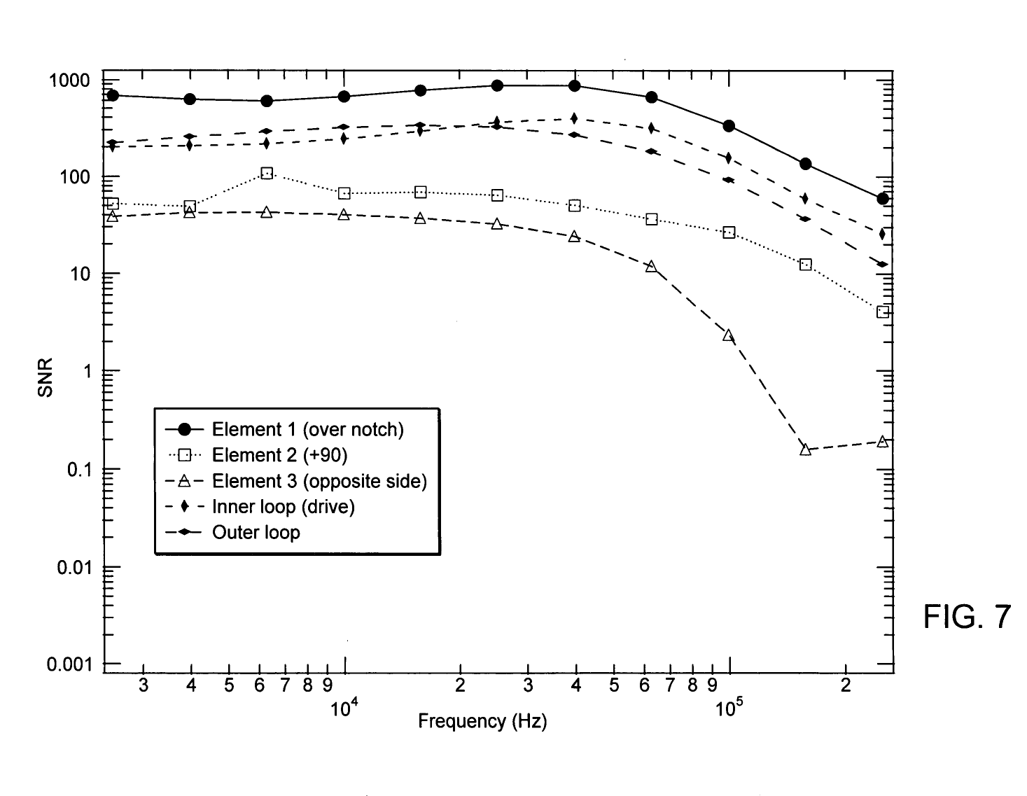

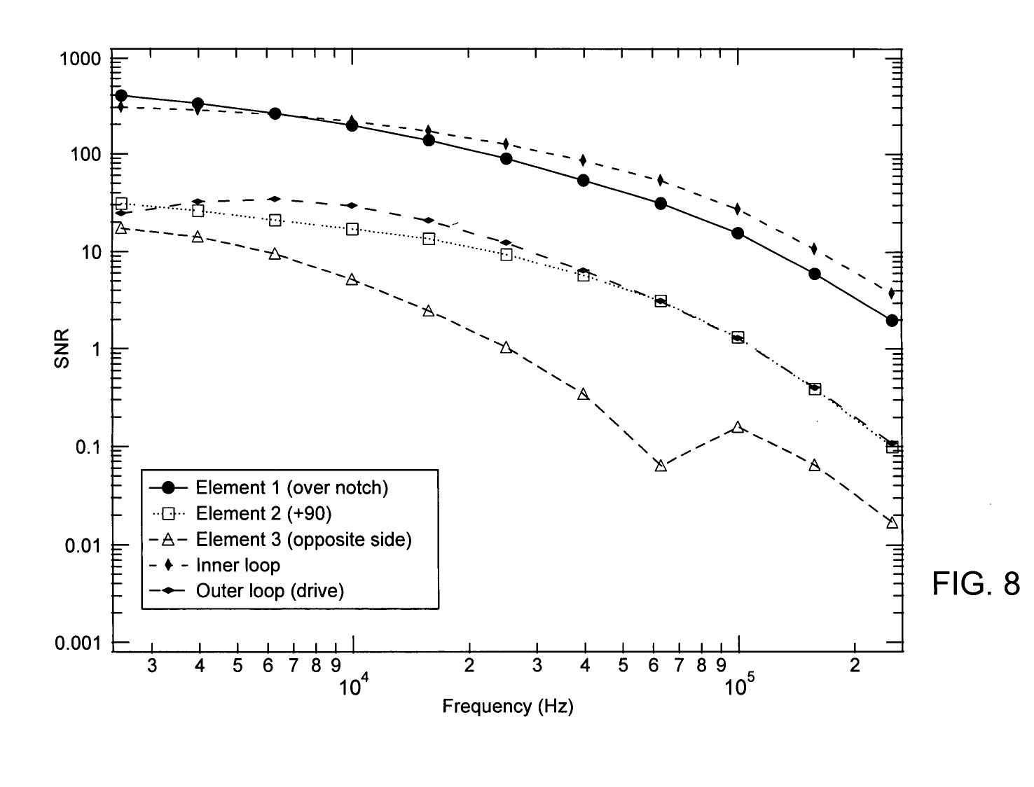

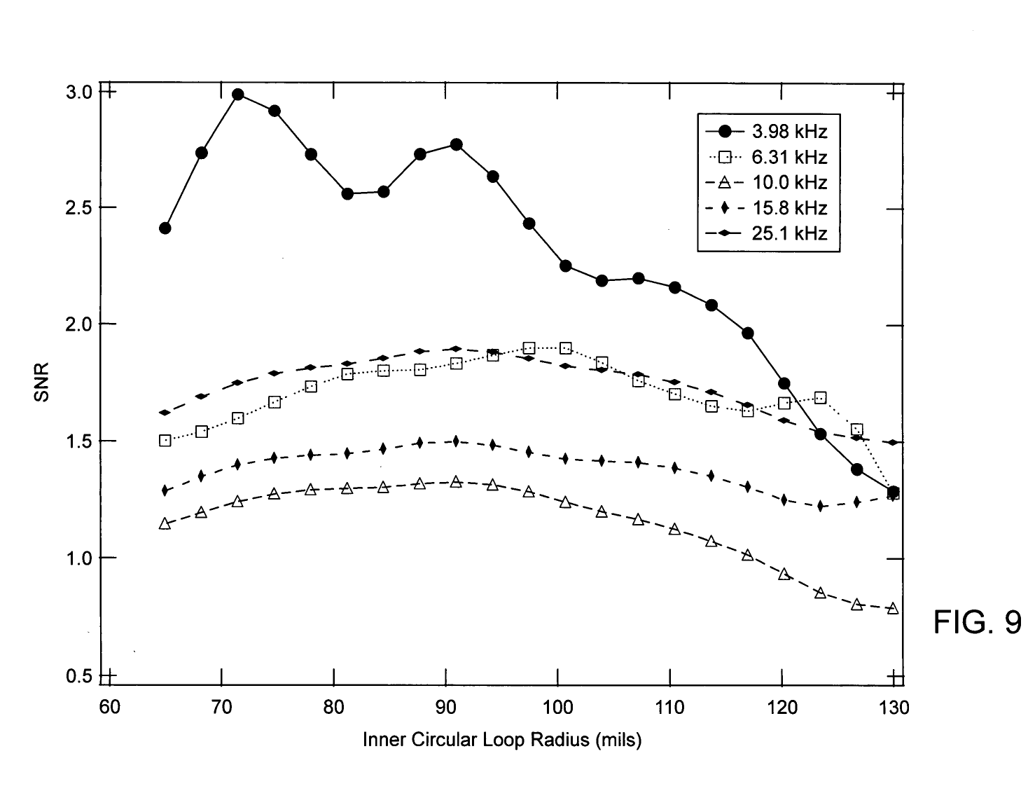

FIGS. 7 and 8 shows representative simulation results for a frequency scan for the upper notch 71 of FIG. 6. The simulation results are expressed in terms of a signal-to-noise ratio (SNR) determined from the change in terminal impedance caused by the presence of the notch. The real and imaginary parts of the effective impedance (Z) for each sense element were determined with and without the flaw being present. The SNR is then expressed as:

$$SNR = \sqrt{\frac{{( {Z}_{r} - {Z}_{ro} )}^{2}}{{( Δ {Z}_{ro} )}^{2}} + \frac{{( {Z}_{i} - {Z}_{io} )}^{2}}{( Δ {Z}_{io} )}}$$

where the subscript r denotes the real part, the subscript i denotes the imaginary part, the subscript o denotes the reference response determined when the notch is not present, and the Δ denotes the estimated noise level based on the reference impedance and the excitation frequency. The noise is obtained from an empirical relation. There is a significant signal with either drive loop, although using the inner loop as the drive provides a larger signal. Element 1 is directly over the notch, element 2 is 90 degrees away, and element 3 is on the opposite side of the fastener. The optimal frequency for this measurement is near 50 kHz for the inner drive loop. For the outer drive loop, the lowest excitation frequency is best. Similar results are obtained for the other notches, except the SNR value decreases due to the increased depth of the flaws. Although not performed in this example, the signal can also be improved by shape filtering the responses, where the measurement response is compared to a signature response of a known notch obtained while spinning around the fastener as described for example, in U.S. Pat. No. 6,784,662 and U.S. patent application Ser. Nos. 10/345,883, filed Jan. 15, 2003 and 11/229,844, filed Sep. 19, 2005, the entire contents of which are incorporated herein by reference.

The effect of the size of the inner drive winding loop on the sensitivity was also examined. In this case, the size of the inner circular drive loop was varied at several excitation frequencies ranging from 4 kHz to 25.1 kHz to determine improvements in the signal level. FIG. 9 shows these results for the sense element centered over the notch itself. Consistent with FIG. 7, which had been performed for a loop radius of 0.130 in., the lowest signal is found at 10 kHz. Larger signal levels are found at slightly higher and slightly lower frequencies. There also appears to be a peak in the signal level when the drive coil radius is approximate 0.090 in., which is essentially the same as the shaft diameter for the fastener or the diameter of the fastener hole. This size drive loop could be easily made from a multiple turn circular drive coil so that the sensor is a hybrid construct as described for example, in U.S. patent application Ser. No. 10/853,009, filed May 24, 2004, the entire contents of which are incorporated herein by reference.

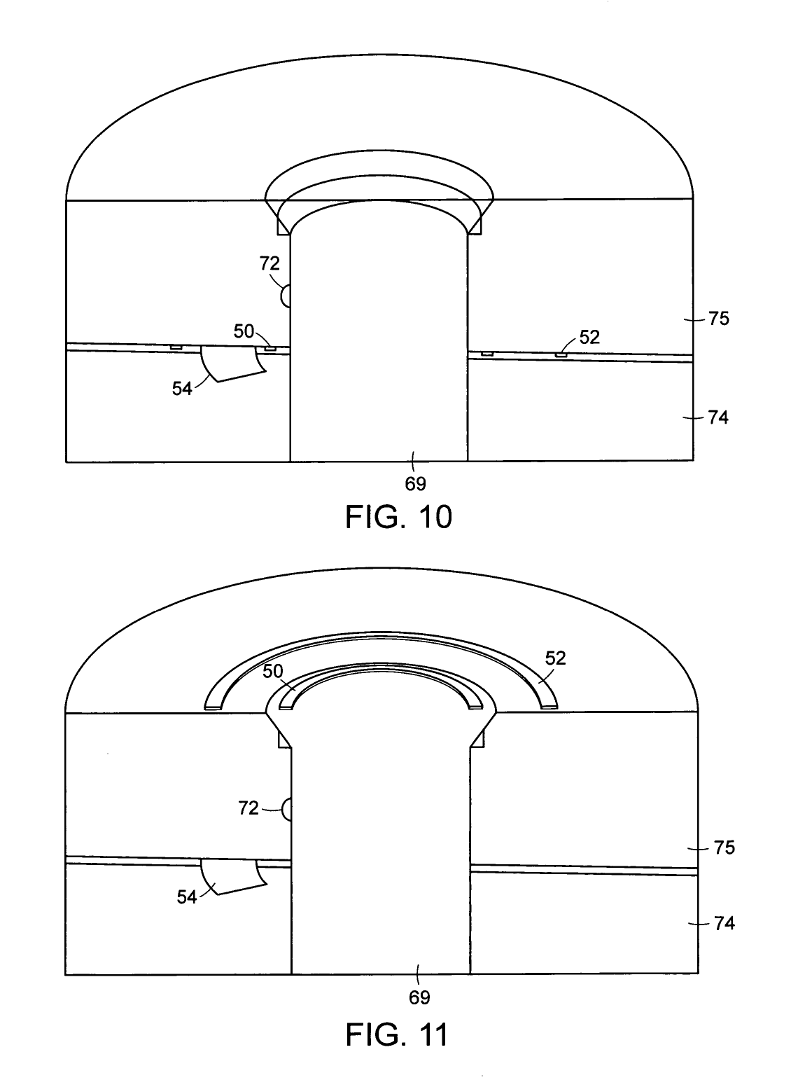

As examples of other embodiments of the use of these sensor arrays, FIG. 10 shows a cross-sectional view of a circular sensor array mounted between two material layers (74 and 75). Although only one sense element of the array is visible, additional sense elements can be positioned around the circumference of the drive windings. This sensor array can be put into place while the joint is being assembled and, with the leads to the sense elements and drive windings brought out to an accessible location, permits inspection for cracks or monitoring of crack growth rates for relatively deep cracks. In particular, this sensor array can provide high sensitivity to cracks that form at the inner corners of the fastener holes. Similarly, FIG. 11 shows an example in which the drive windings (50 and 52) are positioned above the fastener heads while the sense elements (54) are placed between the layers in the joint. This type of mounting scheme is most applicable to situations where the space between the layers is limited. It also allows the use of multiple turn drive winding loops to create larger magnetic fields for sensing the material.

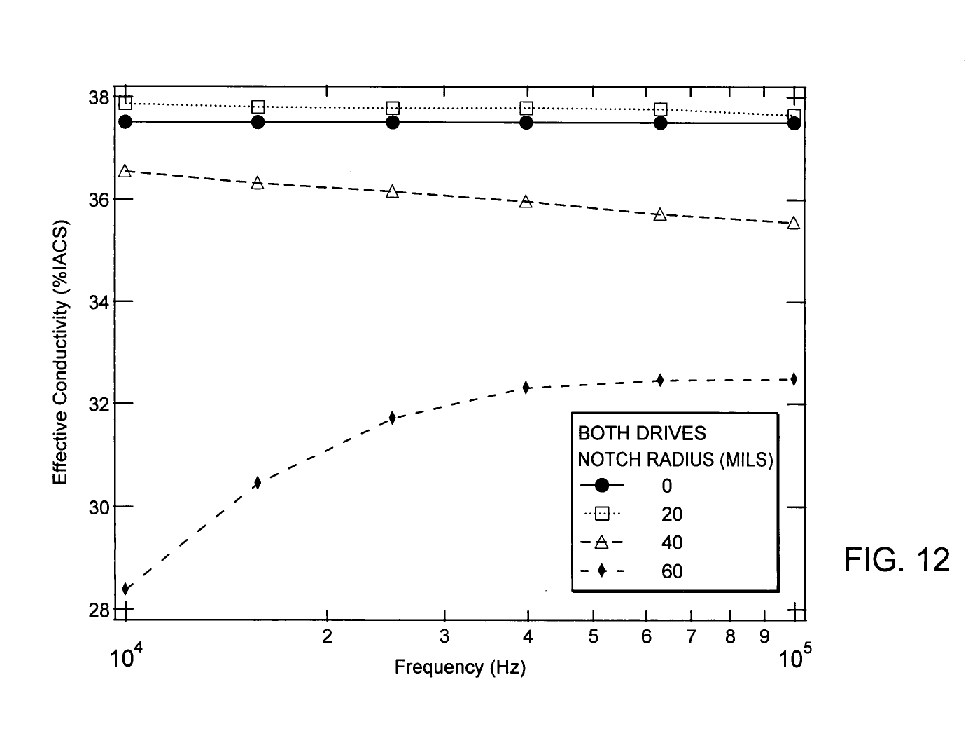

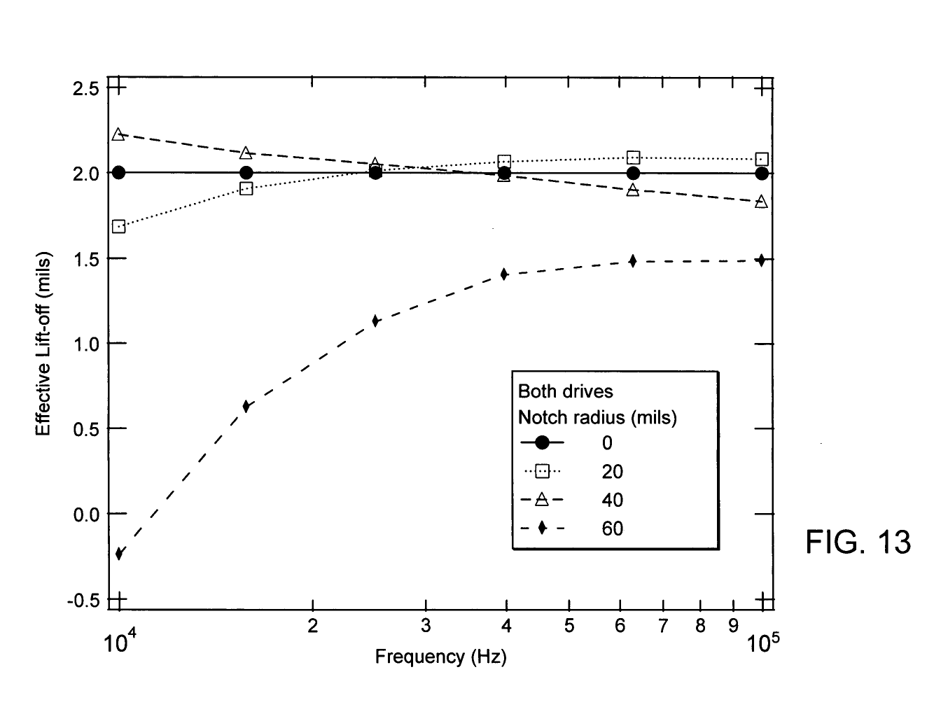

FIGS. 12 and 13 show representative sense element responses for a sensor array mounted between layers and a corner crack at the bottom of the upper layer (75) of FIG. 10. For this example, the current flows in the same direction in each loop so that the field penetration depth is relatively large. The responses were converted to effective properties using measurement grids. A two point calibration was performed and assumed a lift-off of 0.002 in. and bulk conductivities of 21.75 MS/m (37.5% IACS) and 20 MS/m. The inner radius for the sense element loops was 0.135 in. while the outer radius was 0.220 in. The loop spanned 0.0017 to 0.0038 in. below the sense element segments and radii of 0.230 and 0.240 in. The bottom layer was assumed to be 0.002 in. beneath the drive winding. The base material properties for the fastener were a relative permeability of 40 and electrical conductivity of 2 MS/m. The nonmagnetic layers (top and bottom) had an electrical conductivity of 21.75 MS/m. There is a significant change in the effective properties associated with the different notch sizes; the use of the inner drive winding increases sensitivity to smaller flaws initiating in the lower corner of the bore hole.

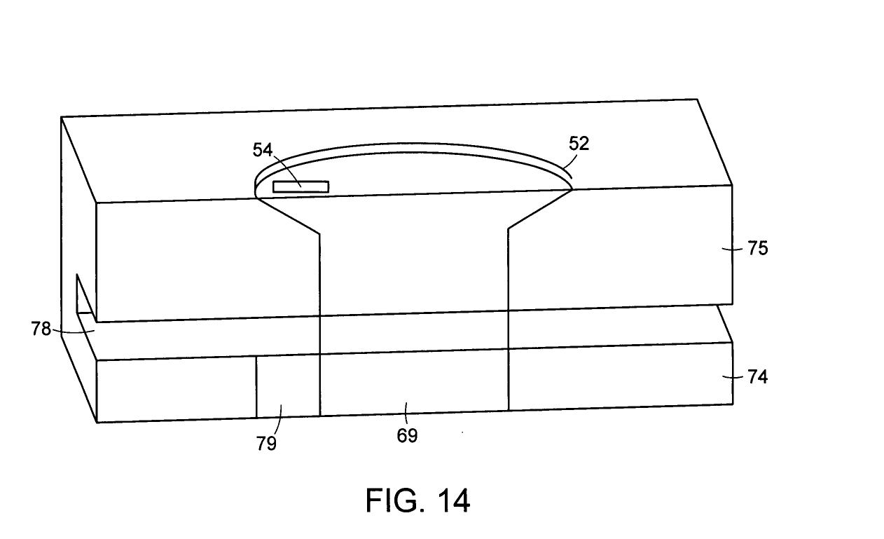

FIG. 14 shows a cross-sectional view for another example geometry. In this case, a crack 79 forms in the lower material layer 74 beneath a sealant groove 78. While FIG. 14 only shows an outer circular winding 52, results were also obtained when an inner drive winding was present. In each case, current was passed through the drive winding loops to create the interrogating magnetic field. The magnetic flux linked by the sense element was calculated so that the effective impedance could be obtained. The outer drive winding loop radius was 0.250, 0.300, 0.350, or 0.400 in. In some cases, an inner drive winding loop was also used. The inner drive winding loop was 0.150, 0.180, 0.210, or 0.240 in. A small sense element was positioned between the two loops and spanned 15°. The response of the sense element at different angular positions around the fastener head was then determined. This simulates the response from rotating one or more sense elements around the fastener and also the response from a surface mounted sensor array having multiple sense elements at various circumferential positions, such as on opposite sides of a drive winding loop. Note that smallest drive winding loop configuration has both of the drive windings over the top of the fastener head. The largest drive winding loop configuration has the inner drive winding loops essentially over the edge at the top of the fastener head. For the intermediate loop sizes the sense element spans the edge at the top of fastener head. The base material properties for the fastener were a relative permeability of 40 and electrical conductivity of 2 MS/m. The remaining material is nonmagnetic and had an electrical conductivity of 1% IACS. In this case, the notch was 0.100 in. long.

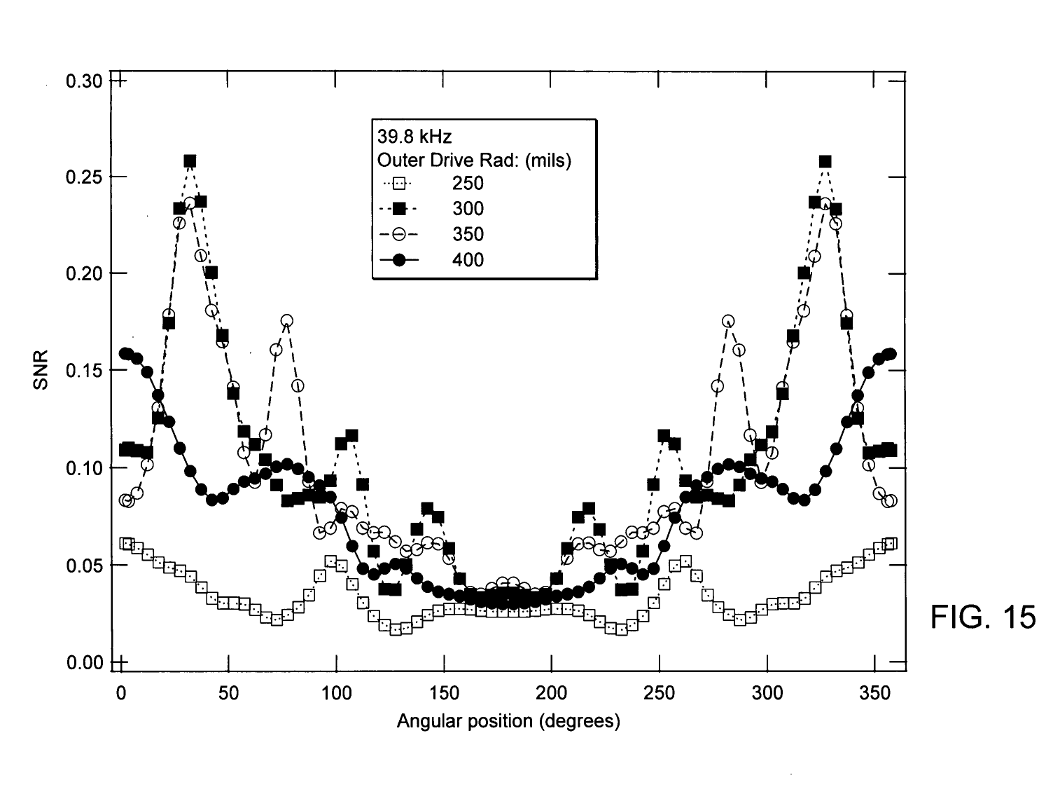

FIG. 15 shows sensitivity results for a single outer drive winding at an excitation frequency of 39.8 kHz. There is also a significant dependence on the size of the drive winding and the position of the sense element. When the drive and sense element are over the top of the fastener head, the fastener effectively shields the magnetic field from the flaw and the SNR value is small. The response improves as the drive winding is made larger than the fastener head and the sense element spans the top edge of the fastener. There is also a significant signal in the sides lobes away from the main signal peak. As the size becomes even larger, the distribution of the side lobes changes, the peak responses shifts to being directly over notch, and the magnitude of the peak response also decreases.

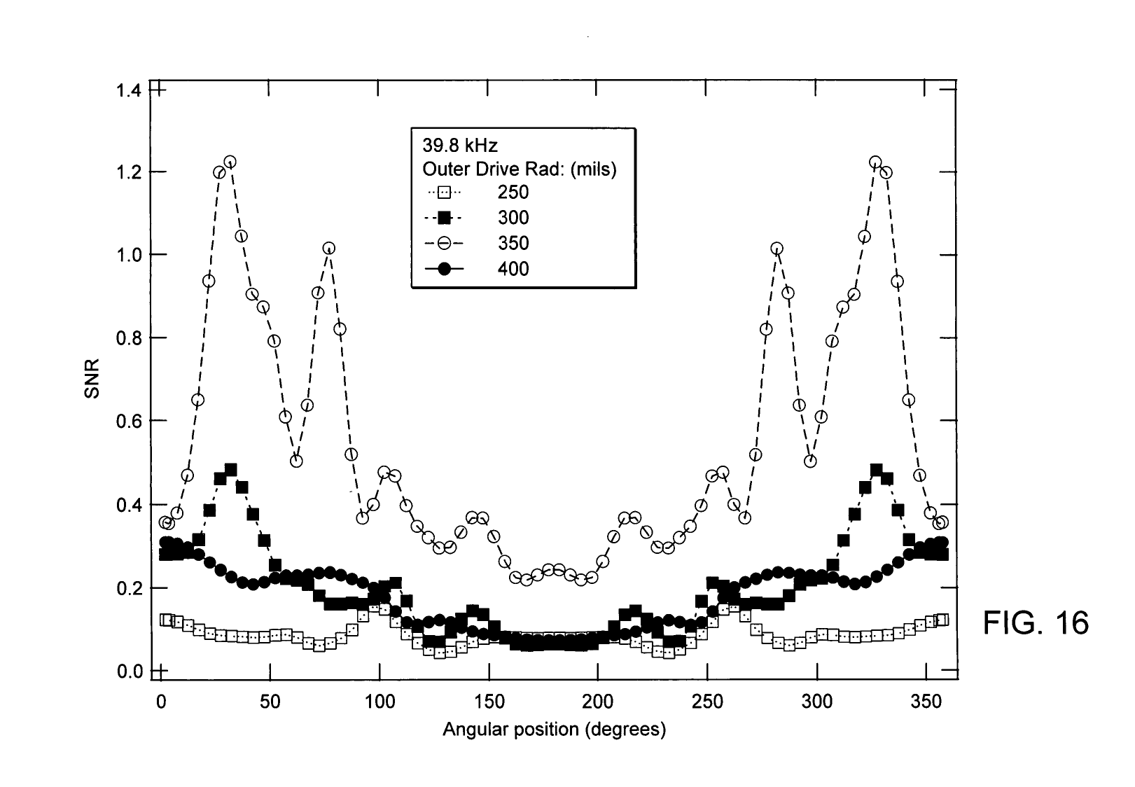

For comparison, FIG. 16 shows the corresponding results when a second, inner, drive winding loop is added. The current through the inner drive winding loop can be adjusted to approximately cancel the field from the outer drive winding in the vicinity of the sense element. Then, the response is only non-zero when the crack or notch is present. To determine the necessary inner drive winding current, the secondary responses without a notch for either an outer or an inner drive current was calculated as listed in Table 1. For these calculations, for an outer drive current amplitude of 1 A, then an inner current of 1 A and a phase of −14° relative to the current in the outer drive winding loop approximately nulls the net magnetic field through the sense element. FIG. 16 shows the improvement in the SNR by using both drive loops. The greatest improvement is observed for the 0.350 in. outer drive loop radius configuration, probably because the applied inner drive current best matches the necessary inner drive winding loop current. Similar improvements in the results are also obtained for even lower excitation frequencies using the same inner drive winding loop current.

TABLE 1
Approximate inner drive winding loop current to cancel sense
element response.

| | Outer Drive Size | Inner Drive Current | |
|---|---|---|---|
| Frequency (kHz) | (in.) | Magnitude (A) | Phase (degrees) |
| 39.8 | 0.250 | 1.88 | −10.8 |
| | 0.300 | 0.87 | −14.6 |
| | 0.350 | 1.03 | −14.4 |
| | 0.400 | 1.31 | −16.5 |
| 100 | 0.250 | 1.71 | −10.7 |
| | 0.300 | 0.83 | −13.4 |
| | 0.350 | 0.94 | −13.5 |
| | 0.400 | 1.09 | −21.0 |

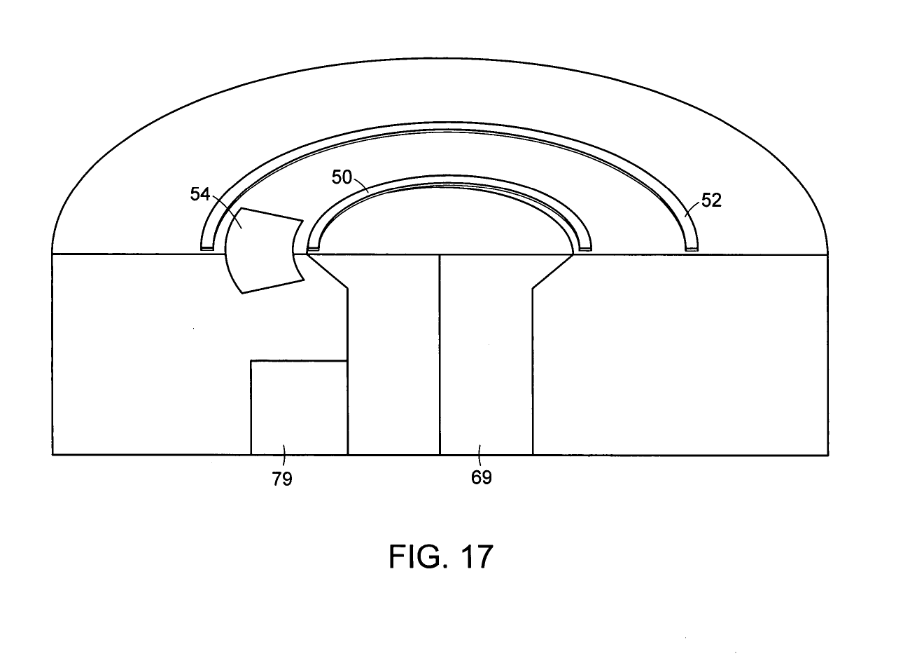

In order to get reliable and reproducible measurements with the circular sensor arrays, it is important to be able to either align the centers of the sensor and any circular features such as fasteners or minimize sensitivity to misalignment. To illustrate the effect of misalignment, consider the geometry of FIG. 17, which shows a cross-section view of a circular sensor placed over a fastener and the centers of the sensor and fastener offset by 0.010 in. In this case the inner and outer circular primary winding loops were connected in series so that current passed through the loops to create the interrogating magnetic field. The sense element was positioned between the two loops and scanned in a circular fashion between the drive winding loops. The base material properties for the fastener were a relative permeability of 40 and electrical conductivity of 2 MS/m. The head of the fastener has a diameter of 0.281 in. and the shaft has a diameter of 0.190 in. The remaining material is nonmagnetic and had an electrical conductivity of 35% IACS. When present, a 0.100 in. long notch was located 0.100 in. below the surface at the bottom of the test material layer.

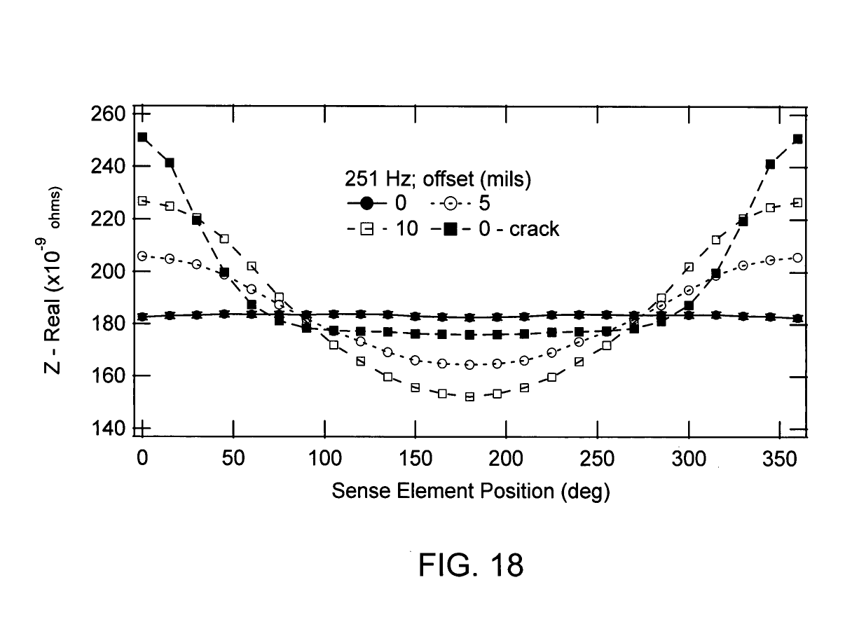

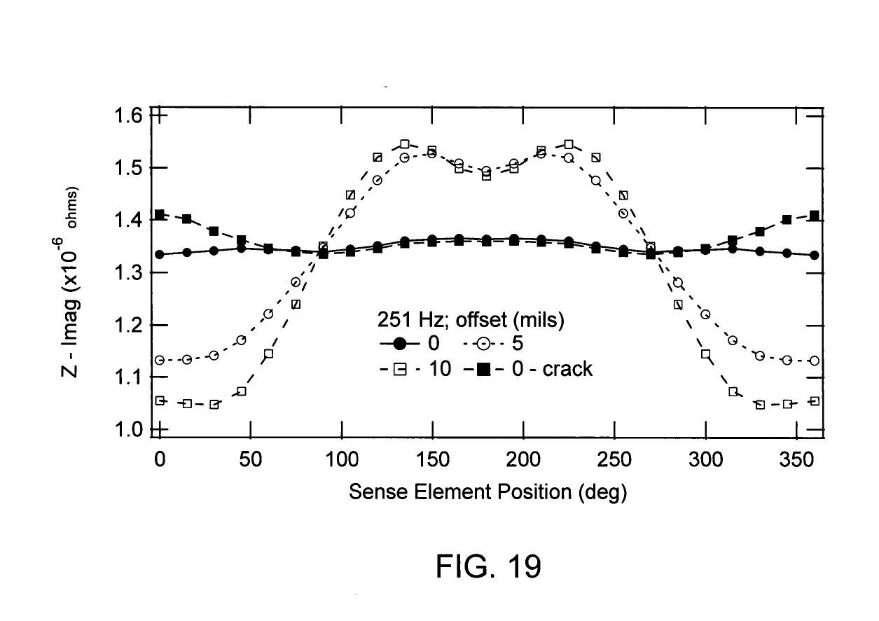

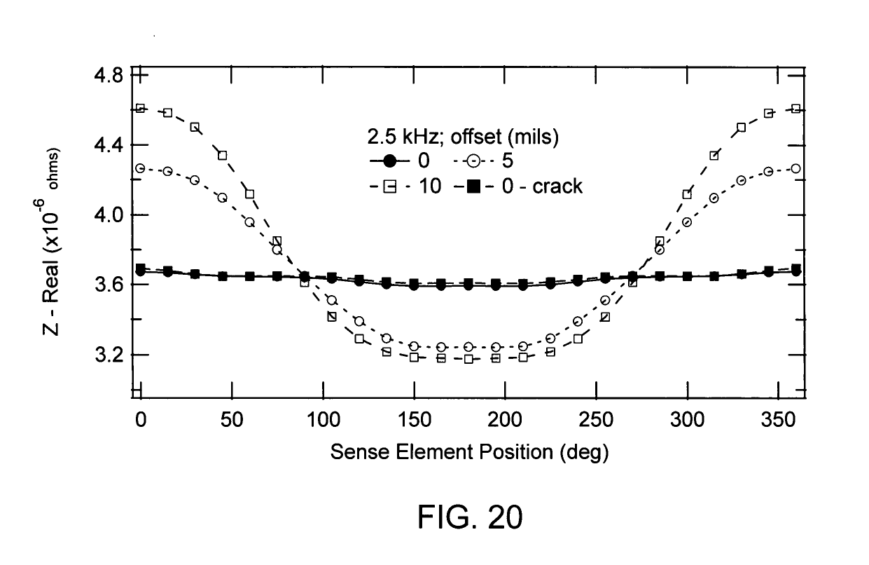

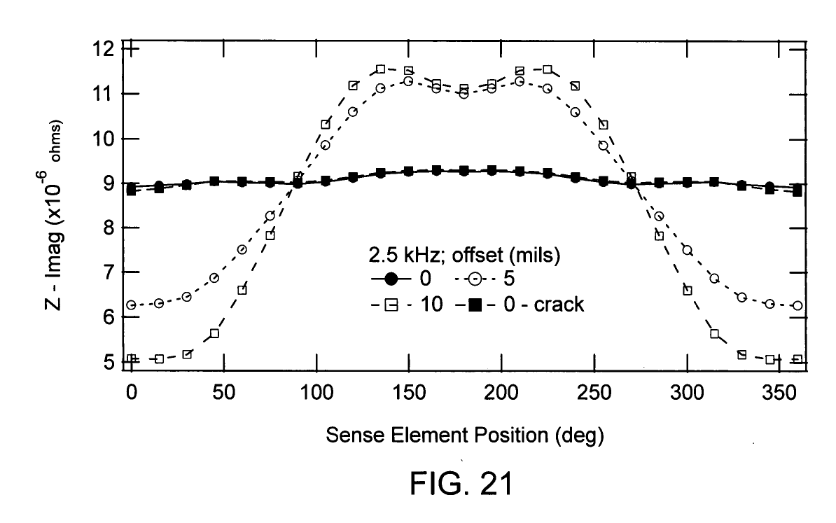

FIGS. 18-21 show plots of the real and imaginary parts of the transimpedance (typically defined as the sense element voltage divided by the drive winding current).

At low frequencies, in this case of order 251 Hz, the notch provides a reasonable signal but the response due to a misalignment or offset of 0.005 to 0.010 in. is comparable to the response for the notch. At the higher frequencies, the notch response is negligible compared to the response due to the offset. This suggests that a high frequency measurements can be used align the sensor while lower frequency measurements can be used for the examination of the test material. It is also significant that the shapes of the responses between a sensor offset and a hidden crack are different. Generally, for the low frequencies, the real part of the offset and crack responses move in the same direction, but the imaginary parts move in the opposite direction. This indicates that a shape-filtering approach can also be used to separate the effects of the offset and the crack. This filtering can be performed in impedance space or after a conversion of the measurement responses into effective material properties.

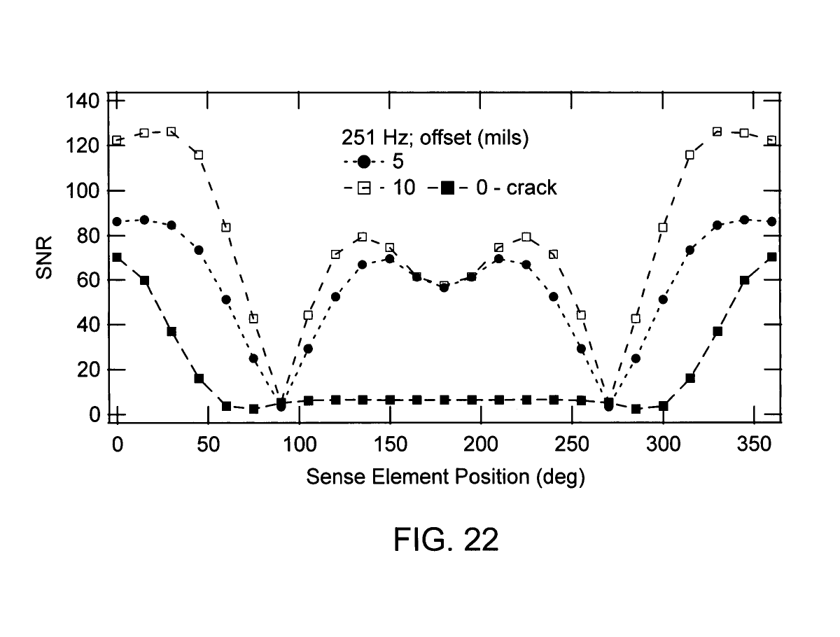

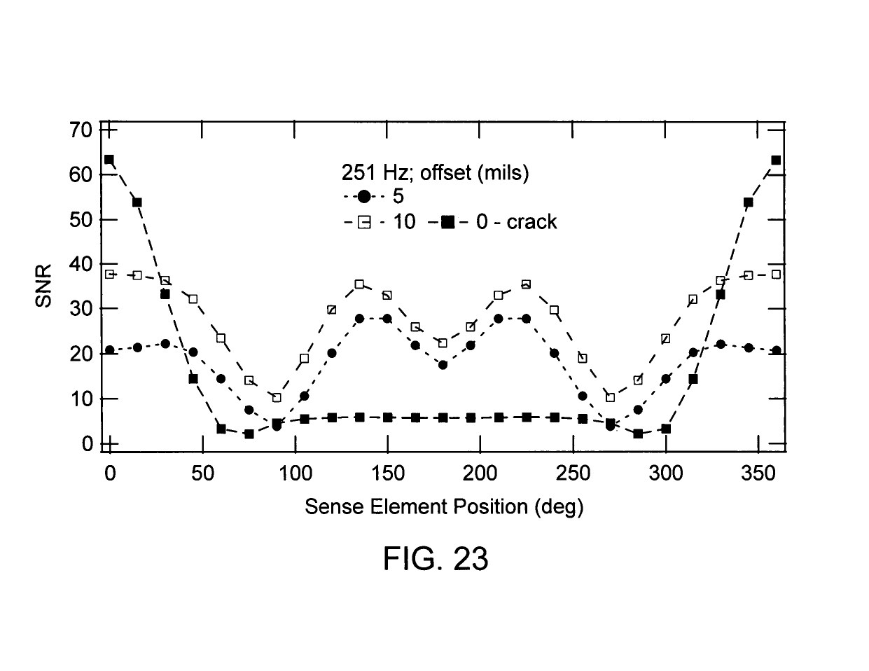

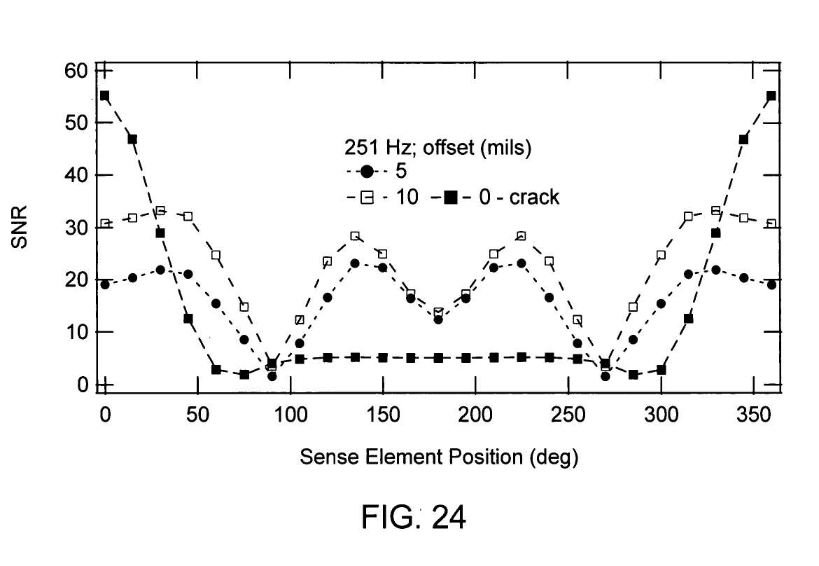

The sensitivity to sensor misalignment with the fastener can also be reduced by modifying the sensor geometry. For example, FIG. 22 shows a plot of the basic sensor response as the sense element position around the fastener and the offset distance are varied. The sense element is sensitive to the crack but more sensitive to the misalignment. FIG. 23 shows the effect of decreasing the radius of the inner drive winding loop by 0.020 in. so that the inner drive winding loop stays over the fastener even when misaligned. This design provides a slight reduction in sensitivity to the crack but greatly reduces the sensitivity to misalignment. This effect is even greater, as shown in FIG. 24, when no current flows through the inner drive winding loop. This indicates that the inner drive winding can be used in aligning the sensor with the fastener, but then only the outer drive winding loop is subsequently used for the examination of the test material.

Clearly, the use of multiple drive winding turns and multiple (high and low) excitation frequencies provide benefits when operating circular sensors and circular sensor arrays. In permanently mounted applications, the response from sense elements at different circumferential positions around the array can be used as inputs to an automated centering algorithm that indicates the direction the sensor array needs to be moved to be centered. These inputs can be the raw or measured transimpedance values or effective properties of the test material. Similarly, when used in a rotating probe or scanning configurations, the sense element response at multiple positions around a fastener, hole, or other circular feature can be used to indicate the misalignment and/or wobble in the measurement. Typically, the measurement responses at three or four equiangular positions around the circumference are used to determine the direction need for aligning the sensor and circular feature.

While the inventions have been particularly shown and described with reference to preferred embodiments thereof, it will be understood to those skilled in the art that various changes in form and details may be made therein without departing from the spirit and scope of the invention as defined by the appended claims.

References incorporated by reference in their entirety:
1. Auld, B. A. and Moulder, J. C. (1999), “Review of Advances in Quantitative Eddy-Current Nondestructive Evaluation,” Journal of Nondestructive Evaluation, vol. 18, No. 1.

What is claimed is:

1. A test circuit comprising:
a drive winding comprising one or more planar electrical conductors for imposing a field in a test material when driven by an electric current, all of the electrical current flowing in one direction about an axis;
at least two planar sense elements proximate to and spaced along the electrical conductors of the drive winding for sensing the response of the test material to the imposed field; and
leads to each sense element.

2. The test circuit as claimed in claim 1 wherein the drive winding conductor is circular.

3. The test circuit as claimed in claim 2 wherein the drive winding conductor further comprises two circular windings with a winding approximately encircling the sense elements.

4. The test circuit as claimed in claim 3 wherein the magnitude and phase of the current through the one winding relative to the second winding is adjusted to zero a sense element response when the test material has uniform electrical properties.

5. The test circuit as claimed in claim 2 wherein the test material includes a circular feature.

6. The test circuit as claimed in claim 5 wherein the feature is a fastener.

7. The test circuit as claimed in claim 6 wherein a drive winding diameter and fastener head diameter are approximately the same.

8. The test circuit as claimed in claim 2 wherein sense elements are equally spaced around the circumference of a drive winding.

9. The test circuit as claimed in claim 2 wherein sense elements are grouped into pairs, with at least one pair having sense elements at different radial distances from the center of the drive winding and at least two pairs of sense elements at different circumferential positions.

10. The test circuit as claimed in claim 2 wherein the leads are perpendicular to the drive winding and in a different plane.

11. The test circuit as claimed in claim 2 wherein the leads include an additional set of conductors terminated with a cross-connection and parallel to the leads to each sense element.

12. The test circuit as claimed in claim 1 wherein the drive winding is in a different plane than the sense elements.

13. The test circuit as claimed in claim 12 wherein the drive winding contains several electrical conductors.

14. The test circuit as claimed in claim 1 wherein a drive winding is in the same plane as the sense elements.

15. The test circuit as claimed in claim 1 further comprising an open center area to accommodate the inspection of raised fastener heads.

16. A method for inspecting a test material comprising:
disposing a sensor proximate to a test material, the sensor having a drive winding comprising one or more planar electrical conductors to impose a field in the test material when driven by electric current, all of the electrical current flowing in one direction about an axis, at least two planar sense elements for sensing the response of the test material to the imposed field; and
measuring a sensor response.

17. The method as claimed in claim 16 wherein the drive winding is circular.

18. The method as claimed in claim 17 wherein the test material includes a fastener.

19. The method as claimed in claim 20 wherein the sense element is spun around the feature.

20. The method as claimed in claim 17 wherein a sense element response is used to align the center of the sensor and the center of a fastener in the test material.

21. The method as claimed in claim 16 wherein the sensor is mounted on the test material surface

22. The method as claimed in claim 16 wherein the test material has at least two layers and the sensor is placed between test material layers.

23. The method as claimed in claim 16 wherein the test material has at least one layer, the sense elements are mounted on one side of a material layer and the drive windings are position on the opposite side of the same material layer.

24. The test circuit as claimed in claim 1 wherein the imposed field is a magnetic field.

25. The method as claimed in claim 16 wherein the imposed field is a magnetic field.
